(19) United States
(12) Patent Application Publication
(10) Pub. No.: US 2024/0343094 A1
(43) Pub. Date: Oct. 17, 2024

(54) PASSENGER-COMPARTMENT COMPONENT FOR AN AIR VENT, AIR VENT AND PRODUCTION METHOD

(71) Applicant: Volkswagen Aktiengesellschaft, Wolfsburg (DE)

(72) Inventor: Zafer YILMAZ, Wolfsburg (DE)

(73) Assignee: Volkswagen Aktiengesellschaft, Wolfsburg (DE)

(21) Appl. No.: 18/634,658

(22) Filed: Apr. 12, 2024

(30) Foreign Application Priority Data
Apr. 12, 2023 (DE) 10 2023 203 296.1

(51) Int. Cl. B60H 1/34

(52) U.S. Cl. CPC B60H 1/34; B60H 2001/3492

(57) ABSTRACT

An interior component for an air vent of a vehicle. The interior component being designed as a grid element for covering a vent opening in the air vent and having at least one grid strut that is designed to extend across a vent opening in the air vent, the grid element being made of plastic. It is provided that the grid element has a one-piece design and is made of a fiber-reinforced plastic, and has a coating that overlays the plastic at least on a visible side of the grid element.

This nonprovisional application claims priority under 35 U.S.C. § 119(a) to German Patent Application No. 10 2023 203 296.1, which was filed in Germany on Apr. 12, 2023, and which is herein incorporated by reference.

### BACKGROUND OF THE INVENTION

### Field of the Invention

The invention relates to an interior component for an air vent of a vehicle, the interior component being designed as a grid element and having at least one grid strut that is designed to extend across a vent opening in the air vent, the grid element having a one-piece design and being made of plastic.

The invention further relates to an air vent for a vehicle, in particular a motor vehicle, including a housing that forms a vent opening, and an interior component situated at the housing and overlaying the vent opening at an end-face side of the housing that is or may be associated with an interior of the vehicle.

The invention further relates to a method for manufacturing the interior component mentioned above.

### Description of the Background Art

Interior components are known from the prior art. Thus, a generic interior component is described in German Utility Model DE 20 2018 103 133 U1, which corresponds to US 2019/0366807, for example, which has a multipart design and is situated at a housing that forms an air duct having a vent opening. The interior component is made of plastic, and has a grid strut that extends across the vent opening. The grid strut is designed as a separate part, and is fastened to a frame of the interior component.

A further air vent having an interior component is known from German Unexamined Patent application DE 10 2020 207 151 A1, which is incorporated herein by reference, and in which the interior component is designed as a grid element and has multiple grid struts that extend in parallel to one another across a vent opening. The grid struts are manufactured as decorative louvers made of plastic, and have a chrome coating.

Furthermore, an interior component for an air vent is known from German Unexamined Patent application DE 10 2018 113 183 A1, which corresponds to US 2019/0366806, and which is designed as a grid element and is made of plastic.

### SUMMARY OF THE INVENTION

It is therefore an object of the present invention to provide an improved interior component which in particular allows at least one particularly long grid strut to be designed, free of support, in such a way that it has sufficient bending stiffness in order to avoid undesirable deformation during operation without marring the external appearance of the interior component.

In an example, the object is achieved by an interior component according to the present invention, and has the advantage that, due to an advantageous selection of material, the grid strut has a particularly rigid and durable design and overcomes the disadvantages stated above. According to the invention, for this purpose it is provided that the grid element has a one-piece design and is made of a fiber-reinforced plastic, and has a coating that overlays the plastic at least on a visible side of the grid element. The fiber reinforcement ensures sufficient stability of the grid strut to guarantee the desired robustness and stability, even for a relatively large longitudinal extension that is free of support. One result of the coating, among others, is that the fibers in the plastic are no longer discernible from the outside. In addition, the coating protects the fiber-reinforced plastic from premature wear or aging effects.

The fibers in the plastic in the region of the grid strut can be oriented in the longitudinal extension of the grid strut. Thus, the fibers extend inside the grid strut in the longitudinal extension of the grid strut or in parallel to same, thus optimizing the robustness and rigidity of the grid strut. For orienting the fibers, they are oriented in an injection molding process or continuous casting process, for example, provided that the plastic is still viscous or liquid.

A lacquer that overlays the plastic is particularly preferably used as a coating. The plastic is thus protected, and the interior component acquires a high-quality appearance. A black lacquer is preferably used.

The coating can preferably be a matte or glossy coating. The appearance of the interior component is thus advantageously adaptable to different constraints.

In particular, the coating can be a chrome coating or a chrome-colored coating. The interior component acquires a particularly high-quality appearance by use of this coating. In addition, the plastic is advantageously concealed by the chrome coating, so that even fibers that are still discernible in the plastic are not visible.

The grid strut can extend free of support at least 80 millimeters, preferably at least 100 millimeters, in particular at least 120 millimeters. The grid strut for the above-mentioned lengths thus lies freely above the vent opening when the interior component is mounted at the air vent. Optionally, the grid element has no transverse strut, oriented perpendicularly with respect to the grid struts, that could support and thus stabilize the grid strut in its longitudinal extension. If the grid element has one or more transverse struts that extend perpendicularly with respect to the at least one grid strut, the support-free sections of the grid strut have a length of at least 80 millimeters, preferably at least 100 millimeters, or particularly preferably at least 120 millimeters. Due to the design of the interior component according to the invention, such lengths without support are made possible without adversely affecting the robustness or rigidity of the grid strut itself.

The housing of the air vent and/or the interior component can have a mount that allow an orientation and/or fastening of the interior component and the housing to one another. Thus, the interior component has one or more fastening protrusions or hooks, for example, that cooperate with appropriate or corresponding receptacles in the housing in order to establish a form-fit connection, in particular without tools.

The method according to the invention is characterized in that the grid element is made of fiber-reinforced plastic, and is provided with a coating that overlays the plastic, at least on a visible side of the grid element. This results in the advantages stated above.

In particular, the grid element can be manufactured using an injection molding process or continuous casting process, wherein in a viscous state of the plastic, the fibers in the plastic are preferably oriented, at least in the region of the grid strut, in such a way that they extend in the longitudinal extension of the grid strut. After the plastic cures, the fibers remain in their oriented state and thus support the grid strut in the longitudinal extension, thus increasing their robustness and in particular bending stiffness.

It can also be provided that the grid element is provided with a matte, glossy, in particular black or chrome-colored coating, in particular with a chrome coating. This results in the advantages stated above.

Further scope of applicability of the present invention will become apparent from the detailed description given hereinafter. However, it should be understood that the detailed description and specific examples, while indicating preferred embodiments of the invention, are given by way of illustration only, since various changes, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an air vent in a simplified perspective illustration;

FIGS. 2A and 2B show an interior component of the air vent in a perspective illustration according to an example; and

FIGS. 3A and 3B show the interior component in a top view according to an example.

### DETAILED DESCRIPTION

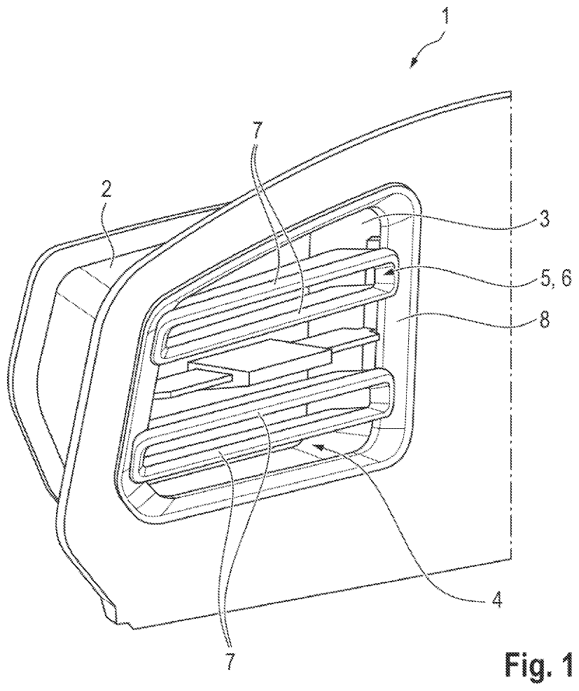

FIG. 1 shows a simplified perspective illustration of an advantageous air vent 1 for a motor vehicle, not illustrated here in greater detail. The air vent 1 has a housing 2 that is inserted or insertable into the dashboard of a motor vehicle, for example. The housing 2 forms an air duct 3 that opens into a vent opening 4 facing the interior of the vehicle.

Situated at the housing 2, facing the vehicle interior, is an interior component 5 which is designed as a grid element 6, and which in the present case has four grid struts 7 that extend in parallel to one another across the vent opening 4. In each case two of the longitudinal struts 7 are connected to one another at their end sides, thus forming a ring. The grid element 6 thus has two rings with sections, forming the grid struts 7, which are situated in parallel to one another and which in each case extend across the vent opening 4 in the shape of strips. On one side the grid struts 7 are also held at a frame 8 or connected thereto in one piece, the frame being fastened to the housing 2. Optionally, the grid struts 7 alone are held directly at the housing 2.

The grid struts 7, in particular in the longitudinal extension, have a length L of at least 80 millimeters, preferably at least 120 millimeters.

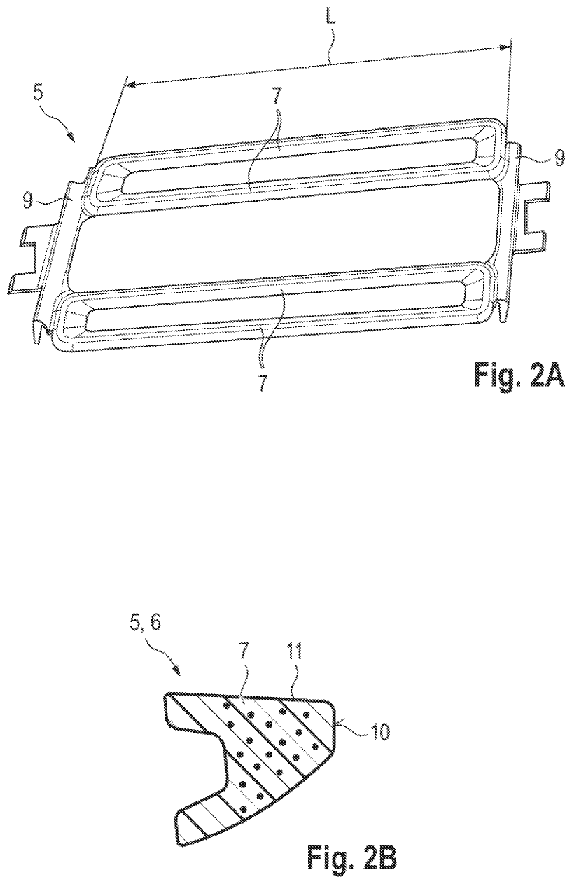

FIG. 2A shows the interior component 5 in a perspective single part illustration. The longitudinal struts 7 are connected to one another, on their rear side facing away from the vehicle interior, by connecting struts 9. In their longitudinal extension the grid struts 7 have a support-free design, so that they are supported only at the end. Thus, in addition to the connecting struts 9 on one side, the grid element 6 has no transverse struts on which the grid struts 7 could be supported.

The interior component 5 as a whole is made of plastic, which is a fiber-reinforced plastic, in particular glass fiber-reinforced or carbon fiber-reinforced plastic. The fibers contained in the plastic each extend in the respective grid struts 7 in the longitudinal extension of the grid struts 7 or in parallel thereto, as shown in simplified form in FIG. 2A by fibers, illustrated in simplified form, at one of the grid struts 7.

FIG. 2B shows a cross section of one of the grid struts 7, which in the cross section each have an identical design. In the cross section the particular grid strut 7 has a V-shaped design, with the grid strut 7 widening or opening in the direction of the housing 2. This results in a tapering visible edge 10 at the front side, facing the vehicle interior when used as intended. Since the fibers extend in the longitudinal extension of the grid strut 7, they are illustrated merely as points in FIG. 2B.

In addition, the particular grid strut 7 is provided with a coating 11, in particular a lacquer coating, which in particular contains a black matte or glossy lacquer. The grid strut 7 is optionally coated with chrome or a chrome-colored coating 11.

As a result of the longitudinal extension of the fibers, the grid struts 7 have a particularly rigid design, and therefore, despite the relatively great length L, prevent unintentional deflection in the direction of the housing 2, for example. In addition, the longitudinal orientation of the fibers results in the advantage that, at least essentially, they do not lead out from the grid struts 7 and therefore are not discernible at the surface. Furthermore, as a result of the coating, the plastic with the fibers lying therein is reliably protected from external influences, and the grid element 6 is enhanced in appearance so that it is concealed by the coating, even if the fibers in the plastic should become discernible at or near the surface.

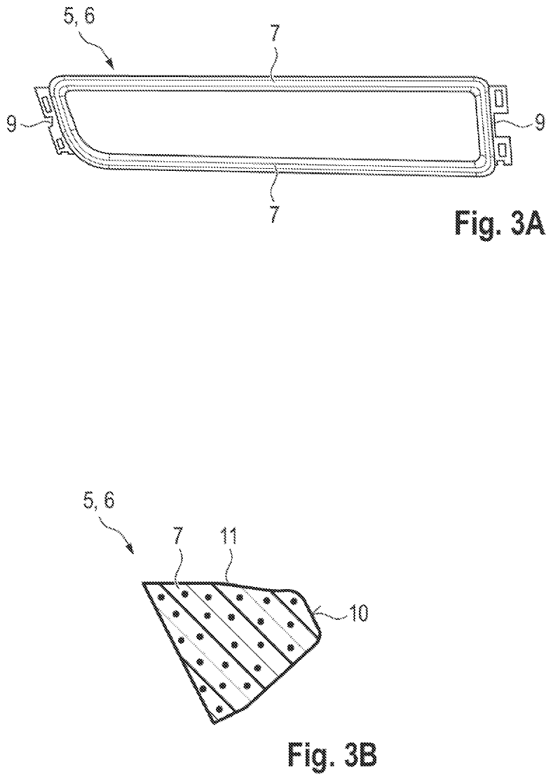

FIGS. 3A and 3B show a further example of the interior component 5, which differs from the preceding example in that the interior component has only two grid struts 7 extending in parallel to one another, as shown in the top view in FIG. 3A. In addition, the grid struts 7, viewed in the cross section as shown in FIG. 3B, have a Δ-shaped cross section. Here as well, the interior component 5 preferably has the coating 11, for example in the form of the chrome coating.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An interior component for an air vent of a vehicle, the interior component being designed as a grid element of the air vent, the interior component comprising at least one grid strut that extends across a vent opening in the air vent, the grid element being made of plastic, the grid element having a one-piece design and is made of a fiber-reinforced plastic, and the grid element having a coating that overlays the plastic at least on a visible side of the grid element.

2. The interior component according to claim 1, wherein fibers in the plastic in the region of the grid strut are oriented in the longitudinal extension of the grid strut.

3. The interior component according to claim 1, wherein the coating is a black lacquer.

4. The interior component according to claim 1, wherein the coating is a matte or glossy lacquer.

5. The interior component according to claim 1, wherein the coating is a chrome coating or a chrome-colored coating.

6. The interior component according to claim 1, wherein the grid strut extends free of support at least 80 millimeters, or at least 100 millimeters, or at least 120 millimeters.

7. An air vent for a vehicle, the air vent comprising:
a housing that forms a vent opening; and
an interior component according to claim 1 being arranged at the housing and overlaying the vent opening at an end-face side of the housing that is associated with an interior of the vehicle.

8. A method for manufacturing an interior component for an air vent of a vehicle, the method comprising:
designing the interior component as a grid element;
covering at least partially a vent opening in the air vent via the grid element; and
providing the grid element with at least one grid strut that is designed to extend across the vent opening, the grid element having a one-piece design and being made of plastic, the grid element being made of fiber-reinforced plastic; and
providing the grid element with a coating that overlays the plastic, at least on a visible side of the grid element.

9. The method according to claim 8, wherein the grid element is manufactured using an injection molding process, and wherein in a still viscous state of the plastic. fibers in the plastic are oriented, at least in the grid strut such that they extend in the longitudinal extension of the grid strut.

10. The method according to claim 8, wherein the grid element is provided with a matte, glossy, black, a chrome-colored, or a chrome coating.
